(19) United States
(12) Patent Application Publication
(10) Pub. No.: US 2012/0286607 A1
(43) Pub. Date: Nov. 15, 2012

(54) VEHICLE DRIVE DEVICE

(75) Inventors: Katsutoshi SHIMIZU, Nukata (JP); Yuya TAKEUCHI, Toyota (JP); Yuya HONDA, Okazaki (JP)

(73) Assignee: AISIN AW CO., LTD., Anjo-shi (JP)

(21) Appl. No.: 13/448,783

(22) Filed: Apr. 17, 2012

(30) Foreign Application Priority Data
May 11, 2011 (JP) 2011-106160

(51) Int. Cl. H02K 9/19

(52) U.S. Cl. 310/90

(57) ABSTRACT

A vehicle drive device including a rotating electrical machine; a through shaft extending through a rotor shaft of the electrical machine; a power transmission mechanism that transmits power between the rotor shaft and the through shaft; a lubricant supply that supplies lubricant inside of the rotor shaft by rotation of the power transmission mechanism; a first bearing placed radially outward of the rotor shaft to support the rotor shaft; and a second bearing placed radially outward of the through shaft to support the through shaft. The lubricant supply includes a lubricant storing portion located between the first bearing and the second bearing at a position below a rotation central axis of the through shaft. The lubricant storing portion has a portion that communicates with an opening located on an axial first direction side of the rotor shaft, at a position above a lowermost part of the opening.

### INCORPORATION BY REFERENCE

The disclosure of Japanese Patent Application No. 2011-106160 filed on May 11, 2011 including the specification, drawings and abstract is incorporated herein by reference in its entirety.

### BACKGROUND OF THE INVENTION

The present invention relates to vehicle drive devices including a rotating electrical machine, a through shaft placed to extend through a cylindrical rotor shaft of the rotating electrical machine in an axial direction, a power transmission mechanism that transmits power between the rotor shaft and the through shaft, a lubricant supply portion that supplies, to the inside of the rotor shaft, lubricant supplied by rotation of the power transmission mechanism, and a case that accommodates at least the rotating electrical machine and the power transmission mechanism.

### DESCRIPTION OF THE RELATED ART

For example, there is a technique described in Japanese Patent Application Publication No. JP-A-2005-278319 shown below as related art of such vehicle drive devices. In the description of the section “Description of the Related Art,” reference characters or terms in Japanese Patent Application Publication No. JP-A-2005-278319 are shown in parentheses “( )” as appropriate. A vehicle drive device described in Japanese Patent Application Publication No. JP-A-2005-278319 (Paragraph [0024], FIGS. 1 and 2, etc.) has a configuration in which rotation of a power transmission mechanism that transmits power between a rotor shaft (rotor shaft 26) and a through shaft (right axle shaft AXR) is used to supply lubricant to a rotating electrical machine (electric motor 20) to cool the rotating electrical machine. Specifically, the lubricant in a case (housing 10) is thrown up by rotation of a differential input gear (final driven gear 53), and the lubricant thus thrown up is supplied to the inside of the rotor shaft.

In the configuration of Japanese Patent Application Publication No. JP-A-2005-278319, as shown in paragraph [0024] and FIG. 1 of this document, the lubricant thrown up by the differential input gear is supplied to the inside of the rotor shaft via a bearing (sixth bearing B6 and eighth bearing B8) that directly or indirectly supports the rotor shaft or the through shaft. However, in this configuration, the amount of lubricant that is supplied to the inside of the rotor shaft is limited to the amount by which the lubricant can flow through the bearing. Accordingly, a sufficient amount of lubricant may not be secured to be supplied to the inside of the rotor shaft.

### SUMMARY OF THE INVENTION

It is therefore desired to implement a vehicle drive device capable of easily securing the amount of lubricant to be supplied to the inside of a rotor shaft.

A vehicle drive device includes: a rotating electrical machine; a through shaft placed to extend through a cylindrical rotor shaft of the rotating electrical machine in an axial direction; a power transmission mechanism that transmits power between the rotor shaft and the through shaft; a lubricant supply portion that supplies, to inside of the rotor shaft, lubricant that is supplied by rotation of the power transmission mechanism; a case that accommodates at least the rotating electrical machine and the power transmission mechanism; a first bearing placed on an axial first direction side as one side in the axial direction with respect to the rotating electrical machine, and placed radially outward of the rotor shaft to support the rotor shaft; and a second bearing placed on the axial first direction side with respect to the first bearing, and placed radially outward of the through shaft to support the through shaft. The lubricant supply portion includes a lubricant storing portion which is located between the first bearing and the second bearing in the axial direction at a position below a rotation central axis of the through shaft, and stores the lubricant, and the lubricant storing portion is formed to have a portion that communicates in the axial direction with an opening located on the axial first direction side of the rotor shaft, at a position above a lowermost part of the opening.

As used herein, the term “rotating electrical machine” is used as a concept including all of a motor (an electric motor), a generator (an electric generator), and a motor-generator that functions both as the motor and the generator as necessary.

According to the above configuration, the lubricant stored in the lubricant storing portion can be directly supplied to the inside of the rotor shaft via the portion communicating with the opening of the rotor shaft in the axial direction. Note that since the lubricant storing portion is formed between the first bearing and the second bearing in the axial direction, the lubricant can be easily supplied to the inside of the rotor shaft via neither the first bearing nor the second bearing by using, e.g., a configuration of supplying the lubricant to the lubricant storing portion from radially outside. Thus, the amount of lubricant to be supplied to the inside of the rotor shaft can be more easily secured as compared to the case where the lubricant needs to be supplied to the inside of the rotor shaft via the first bearing and the second bearing.

Moreover, with the configuration in which only an upper part of the lubricant storing portion communicates with the opening of the rotor shaft in the axial direction, the lubricant overflowing the lubricant storing portion is supplied to the inside of the rotor shaft. This allows impurities (foreign matter etc.) contained in the lubricant to be deposited in a lower part of the lubricant storing portion, whereby circulation of the impurities can be suppressed.

The first bearing and the second bearing may be arranged to have an overlapping portion as viewed in the axial direction, and the lubricant storing portion may be formed to have a region that overlaps both the first bearing and the second bearing as viewed in the axial direction.

As used herein, regarding arrangement of two members, the term “overlap” as viewed in a predetermined direction means that when the predetermined direction is a viewing direction and a viewing point is shifted in each direction perpendicular to the viewing direction, the viewing point from which the two members are seen to overlap each other is present at least in some regions.

According to this configuration, the vehicle drive device including the lubricant storing portion can be implemented while suppressing an increase in size of the device in a radial direction. Moreover, in the case of using a configuration of supplying a part of the lubricant stored in the lubricant storing portion to the first bearing and the second bearing to lubricate these bearings, a configuration of supplying the lubricant to the first bearing and the second bearing can be simplified.

The vehicle drive device may further include a first annular member that is placed on the axial first direction side of the first bearing to define an axial second direction side of the lubricant storing portion, which is an opposite side from the axial first direction side, and a second annular member that is placed on the axial second direction side of the second bearing to define the axial first direction side of the lubricant storing portion. The first annular member may include a first radially extending portion formed to extend in a radial direction of the rotor shaft and having a radially inner end portion located radially inward of the opening, and an axially extending portion formed to extend from the radially inner end portion of the first radially extending portion to the axial second direction side and having a tip end located inside the rotor shaft. The second annular member may include a second radially extending portion formed to extend in the radial direction and having a radially inner end portion located radially inward of the radially inner end portion of the first radially extending portion, and a through hole extending through the second radially extending portion in the axial direction is formed below a bottom of the radially inner end portion of the first radially extending portion.

According to this configuration, since the radially inner end portion of the second radially extending portion is located radially inward of the radially inner end portion of the first radially extending portion, a large part of the lubricant overflowing the lubricant storing portion can be guided toward the first annular member, namely toward the rotor shaft. At this time, since the first annular member includes the axially extending portion having the tip end located inside the rotor shaft, the lubricant guided toward the rotor shaft can be efficiently supplied to the inside of the rotor shaft by causing the lubricant to flow along the axially extending portion.

Moreover, since the through hole extending through the second radially extending portion in the axial direction is formed below the bottom of the radially inner end portion of the first radially extending portion, a constant amount of lubricant can be actively caused to flow toward the second annular member, whereby, e.g., the second bearing can be lubricated.

The first annular member is placed on a side in the axial direction where the first bearing is provided with respect to the lubricant storing portion. The first annular member may be used to supply to the first bearing a part of the lubricant overflowing the lubricant storing portion toward the first annular member.

The power transmission mechanism may include a throwing member that throws up the lubricant in the case. The lubricant supply portion may include a lubricant receiving portion that receives the lubricant thrown up by the throwing member, and a lubricant flow passage that allows the lubricant received by the lubricant receiving portion to flow to the lubricant storing portion. The lubricant storing portion may be formed in a lower part of a circumferential continuous space that is formed between the first bearing and the second bearing in the axial direction and that is continuous in a circumferential direction of the rotor shaft. The lubricant flow passage may open at a position above the lubricant storing portion in the circumferential continuous space.

According to this configuration, the lubricant can be supplied to the lubricant storing portion by a simple configuration using gravity and surface tension. In particular, the lubricant can be supplied from the lubricant flow passage to the lubricant storing portion by merely dropping the lubricant from the opening of the lubricant flow passage.

### BRIEF DESCRIPTION OF THE DRAWINGS

FIG. 1 is a cross-sectional view of a vehicle drive device according to an embodiment of the present invention taken along an axial direction;

FIG. 2 is a cross-sectional view taken along line II-II in FIG. 1;

FIG. 3 is a schematic view of a vehicle according to the embodiment of the present invention;

FIG. 4 is a partial enlarged view of FIG. 1;

FIG. 5 is a cross-sectional view taken along line V-V in FIG. 4; and

FIG. 6 is a partial cross-sectional view of a vehicle drive device according to another embodiment of the present invention taken along an axial direction.

### DETAILED DESCRIPTION OF THE EMBODIMENTS

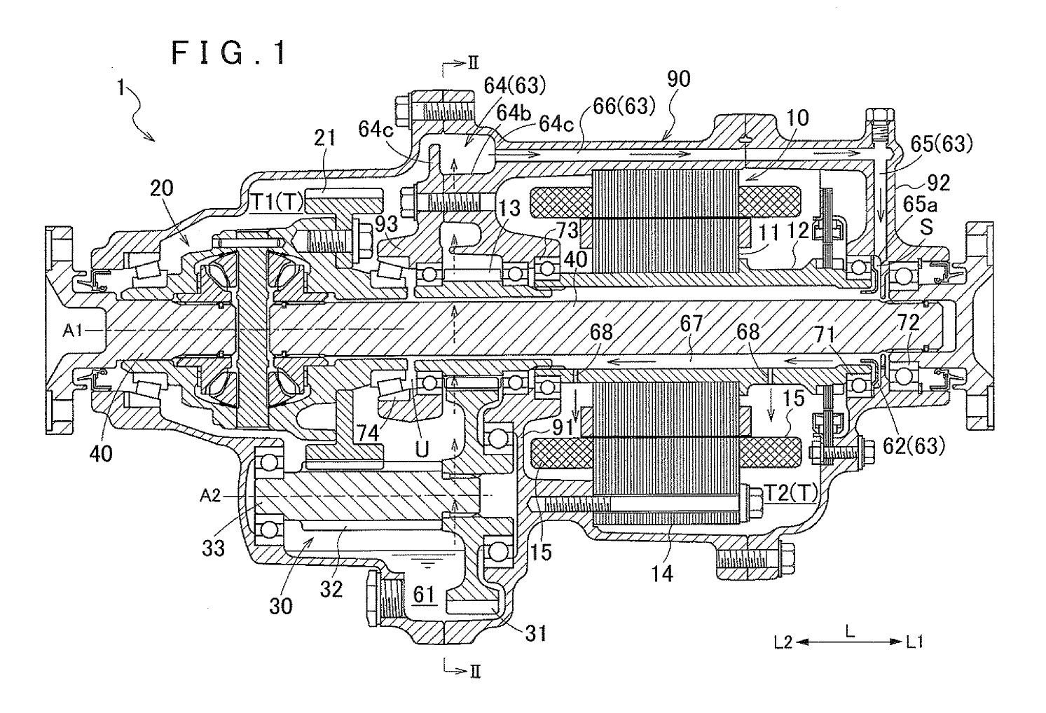

An embodiment of a vehicle drive device according to the present invention will be described with reference to the accompanying drawings. As shown in FIG. 1, the vehicle drive device (hereinafter simply referred to as the “drive device”) according to the present embodiment includes a rotating electrical machine 10, a differential gear mechanism 20, and a counter gear mechanism 30 in a case 90. A vehicle 100 (see FIG. 3) having the drive device 1 mounted thereon is configured to be able to obtain a driving force for running, by an output torque of the rotating electrical machine 10 which is transmitted to the differential gear mechanism 20 via the counter gear mechanism 30. Specifically, in the present embodiment, as shown in FIG. 3, the drive device 1 is a drive device that drives wheels 50 (rear wheels) on the rear side of the vehicle 100. The configuration of the drive device 1 according to the present embodiment will be described in detail below. In the present embodiment, the differential gear mechanism 20 and the counter gear mechanism 30 form the “power transmission mechanism” in the present invention.

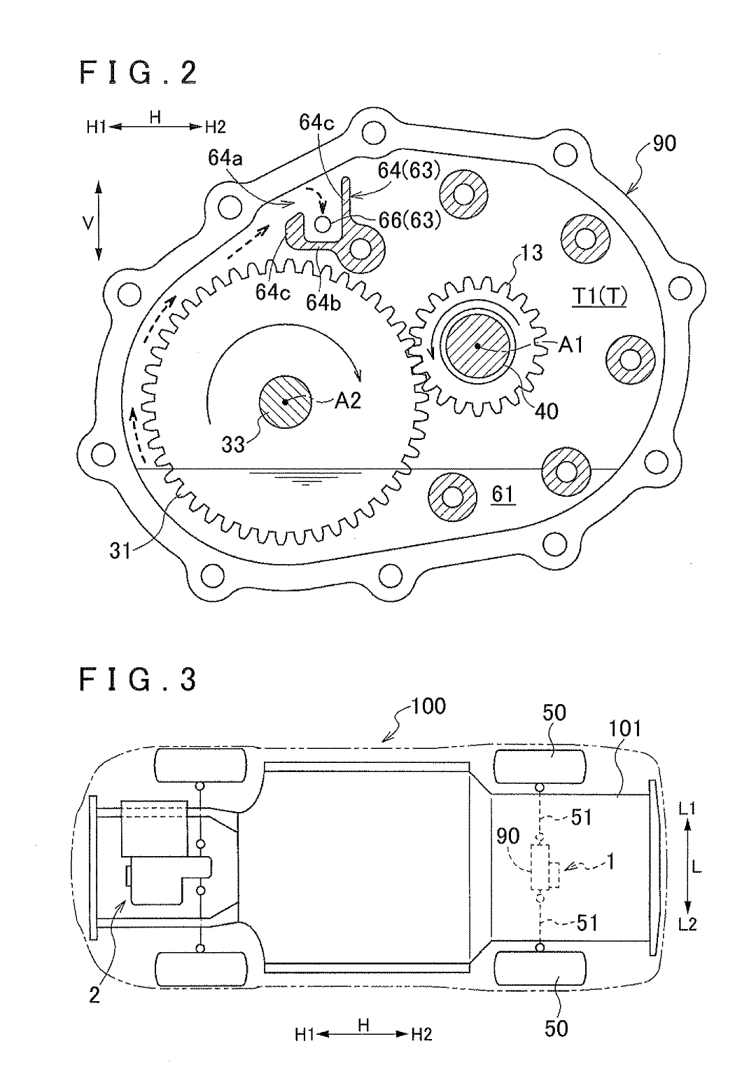

In the following description, the “axial direction L” is defined based on a first axis A1 (see FIGS. 1 and 2) as a central axis of the rotating electrical machine 10 unless otherwise specified. In the present embodiment, the “axial first direction L1” represents the direction (the right direction in FIG. 1) from a rotating electrical machine output gear 13 toward a rotor core 11 along the axial direction L, and the “axial second direction L2” represents the direction (the left direction in FIG. 1) opposite to the axial first direction L1 Note that the direction of each member represents the direction of that member in the assembled state of the drive device 1. The direction of each member and the relation (e.g., “parallel,” “perpendicular,” etc.) between two members regarding the direction in which the two members are arranged are used as a concept including a displacement according to a manufacturing error. Such a manufacturing error is caused by, e.g., a displacement within the range of tolerance of the dimensions or the attachment position.

In the following description, the terms “above” and “below” are defined based on the vertical direction V (see FIG. 2) in the state in which the drive device 1 is mounted on the vehicle 100, the term “above” represents upward in FIG. 2, and the term “below” represents downward in FIG. 2, unless otherwise specified. Similarly, the terms “front” and “rear” are defined based on the longitudinal direction H (see FIGS. 2 and 3) of the vehicle 100 in the state in which the drive device 1 is mounted on the vehicle 100, the term “front” represents leftward (forward H1 of the vehicle) in FIGS. 2 and 3, and the term “rear” represents rightward (rearward H2 of the vehicle) in FIGS. 2 and 3. In the present embodiment, the drive device 1 is mounted on the vehicle 100 so that the axial direction L becomes parallel to a left-right direction of the vehicle 100.

1. Overall Configuration of Drive Device

First, the overall configuration of the drive device 1 according to the present embodiment will be described. As shown in FIG. 1, the drive device 1 includes the rotating electrical machine 10, the differential gear mechanism 20, the counter gear mechanism 30, and the case 90. The rotating electrical machine 10 is provided as a driving force source of the wheels 50 (see FIG. 3). The rotating electrical machine 10 includes a stator 14 fixed to the case 90, and the rotor core (a rotor main body portion) 11 rotatably supported radially inside the stator 14. The rotor core 11 is fixed to a rotor shaft 12, and the rotor core 11 is drivingly coupled via the rotor shaft 12 to the rotating electrical machine output gear 13 that outputs a torque of the rotating electrical machine 10.

Note that as used herein, the expression “drivingly coupled” refers to the state in which two rotating elements are coupled together so as to be able to transmit a driving force therebetween, and is used as a concept including the state in which the two rotating elements are coupled together so as to rotate together, or the state in which the two rotating elements are coupled together so as to be able to transmit a driving force therebetween via one or more transmission members. Such transmission members include various members that transmit rotation at the same speed or after changing the speed of the rotation, and for example, include a shaft, a gear mechanism, a belt, a chain, etc. Such transmission members may include an engagement element that selectively transmits rotation and a driving force, such as, e.g., a friction engagement element and a meshing engagement element.

In the present embodiment, the rotating electrical machine output gear 13 is placed on the axial second direction L2 side with respect to the rotor core 11 so as to be coaxial with the rotor shaft 12 and to rotate together with the rotor shaft 12. Specifically, the rotating electrical machine output gear 13 is fixed to the rotor shaft 12 by spline engagement so as not to be rotatable relative to the rotor shaft 12. Thus, in the present embodiment, the rotor core 11 is drivingly coupled to the rotating electrical machine output gear 13 via the rotor shaft 12 so as to rotate together with the rotating electrical machine output gear 13.

A first bearing 71, which is placed radially outward of the rotor shaft 12 to support the rotor shaft 12, is provided on the axial first direction L1 side with respect to the rotating electrical machine 10 (more specifically, the rotor core 11 of the rotating electrical machine 10), and a third bearing 73, which is placed radially outward of the rotor shaft 12 to support the rotor shaft 12, is provided on the axial second direction L2 side with respect to the rotating electrical machine 10 (more specifically, the rotor core 11 of the rotating electrical machine 10). As shown in FIG. 1, the first bearing 71 is placed on an end wall 92 of the case 90, and the third bearing 73 is placed on a partition wall 91 of the case 90.

In the present embodiment, a radially inner portion of the rotor shaft 12 is formed in a hollow cylindrical shape, and a shaft inner flow passage 67 is formed by using this hollow portion. A through flow passage 68 that allows the shaft inner flow passage 67 to communicate with the outer peripheral surface of the rotor shaft 12 in the radial direction is formed in the rotor shaft 12. As described below, the drive device 1 includes a lubricant supply portion 63 that supplies lubricant to the rotating electrical machine 10, and the lubricant supplied by the lubricant supply portion 63 is supplied via the shaft inner flow passage 67 and the through flow passage 68 to a coil end portion 15 of the stator 14 to cool the coil end portion 15.

The differential gear mechanism 20 is a mechanism (an output differential gear mechanism) having a differential input gear 21 and distributing a torque (in this example, an output torque of the rotating electrical machine 10) transmitted to the differential input gear 21 to the plurality of wheels 50 (see FIG. 3). In the present embodiment, the differential gear mechanism 20 is formed by a differential gear mechanism using a plurality of bevel gears that mesh with each other. The differential gear mechanism 20 is drivingly coupled to each of the left and right wheels 50 via an output shaft 40 provided on both sides in the axial direction L, and the torque transmitted to the differential input gear 21 is distributed to the left and right wheels 50 (in this example, the rear wheels) via the differential gear mechanism 20 and the output shaft 40. In the present embodiment, the differential gear mechanism 20 is placed on the axial second direction L2 side with respect to the rotating electrical machine 10. In the present embodiment, the output shaft 40 corresponds to the “through shaft” in the present invention.

A second bearing 72, which is placed radially outward of the output shaft 40 to support the output shaft 40, is provided on the axial first direction L1 side with respect to the first bearing 71. A fourth bearing 74, which is placed radially outward of the output shaft 40 to support the output shaft 40, is provided on the axial second direction L2 side with respect to the third bearing 73. Note that in this example, the output shaft 40 is indirectly supported by the fourth bearing 74 via the differential gear mechanism 20. As shown in FIG. 1, the second bearing 72 is placed on the end wall 92 of the case 90, and the fourth bearing 74 is placed on the partition wall 91 (more precisely, a support member 93 fixed to the partition wall 91) of the case 90.

Although details will be omitted, a rotation shaft 51 (a drive shaft etc., see FIG. 3) that transmits a driving force to the wheels 50 is coupled to the opposite side of the output shaft 40 from a portion coupled to the differential gear mechanism 20, and the output shaft 40 and the wheels 50 rotate in the same direction. As shown in FIG. 1, a large portion (a portion on the side the output shaft 40 is coupled to the differential gear mechanism 20) of the output shaft 40 is accommodated in the case 90.

The counter gear mechanism 30 is a mechanism that transmits an output torque of the rotating electrical machine 10 to the differential input gear 21. Specifically, the counter gear mechanism 30 has a first gear 31 that meshes with a rotating electrical machine output gear 13 to which the output torque of the rotating electrical machine 10 is transmitted, a second gear 32 that is placed on the axial second direction L2 side with respect to the first gear 31 and that meshes with the differential input gear 21, and a counter shaft 33 that couples the first gear 31 to the second gear 32. In the present embodiment, the second gear 32 is integrally formed on the outer peripheral surface of the counter shaft 33, and the first gear 31 is fixed to the counter shaft 33 by spline engagement so as not to be rotatable relative to the counter shaft 33.

In the present embodiment, the counter gear mechanism 30 is placed on the axial second direction L2 side with respect to the rotating electrical machine 10, and is also placed to have a portion that overlaps the differential gear mechanism 20 as viewed in the radial direction of the rotating electrical machine 10. The first gear 31 is placed between the rotating electrical machine 10 (more specifically, the rotor core 11 of the rotating electrical machine 10) and the differential input gear 21 in the axial direction L.

With such a configuration as described above, a torque in the same direction as the rotation direction of the rotating electrical machine 10 is transmitted to the wheels 50 during running of the vehicle 100. Since the first gear 31 is always drivingly coupled to the output shaft 40 via the counter gear mechanism 30 and the differential gear mechanism 20, the first gear 31 rotates with rotation of the output shaft 40 (that is, running of the vehicle). As described below, the first gear 31 is configured to throw up the lubricant (oil) stored in the case 90 when rotating, and the lubricant thrown up by the first gear 31 is supplied to the rotating electrical machine 10 via the lubricant supply portion 63. In the present embodiment, the first gear 31 corresponds to the “throwing member” in the present invention.

As described above, in the present embodiment, the drive device 1 is configured to drive the rear wheels of the vehicle 100. In this example, as shown in FIG. 3, the vehicle 100 is provided with a second drive device (a second drive device 2) that drives front wheels. For example, the drive device according to the present invention may be used as the second drive device 2, or a drive device including an internal combustion engine as a driving force source of the wheels or a drive device including both an internal combustion engine and a rotating electrical machine as driving force sources of the wheels may be used as the second drive device 2. The internal combustion engine is a motor that outputs power by fuel combustion, and for example, a spark ignition engine such as a gasoline engine, a compression ignition engine such as a diesel engine, etc. may be used as the internal combustion engine. Note that other possible configurations include a configuration that does not include the second drive device (the second drive device 2), and a configuration in which the drive device 1 is placed in a front part of the vehicle so that the front wheels of the vehicle 100 are driven by the drive device 1.

The case 90 is configured to accommodate the rotating electrical machine 10, the differential gear mechanism 20, and the counter gear mechanism 30. In this example, a part of the output shaft 40 and the rotor shaft 12 are also accommodated in the case 90. Specifically, the case 90 includes the end wall 92 defining a space on the axial first direction L1 side of a case inner space T formed inside the case 90, and also includes the partition wall 91 partitioning the case inner space T in the axial direction L. This partition wall 91 divides the case inner space T into a first accommodating chamber T1 as an accommodating space on the axial second direction L2 side and a second accommodating chamber T2 as an accommodating space on the axial first direction L1 side. Both the differential gear mechanism 20 and the counter gear mechanism 30 are accommodated in the first accommodating chamber T1, and the rotating electrical machine 10 is accommodated in the second accommodating chamber T2.

In the present embodiment, the rotating electrical machine 10 and the differential gear mechanism 20 are coaxially placed in the case 90. In order to implement this arrangement configuration, in the present embodiment, the rotor shaft 12 is formed in a hollow cylindrical shape, and the output shaft 40 is placed to extend through the rotor shaft 12. The differential input gear 21 is placed coaxially with the differential gear mechanism 20. Thus, in this example, the rotating electrical machine 10, the differential input gear 21, and the output shaft 40 are placed coaxially.

In the present embodiment, the counter gear mechanism 30 is placed in the case 90 on an axis (a second axis A2) different from an axis (the first axis A1) on which the rotating electrical machine 10 and the differential gear mechanism 20 are placed. In this example, the first axis A1 and the second axis A2 are placed parallel to each other, and the second axis A2 is placed below the first axis A1 (see FIG. 2). Thus, in the present embodiment, the rotation central axis of the counter shaft 33 is placed below the rotation central axis of the rotating electrical machine 10. Note that in the present embodiment, as shown in FIG. 2, the position of the second shaft A2 with respect to the first axis A1 in the up-down direction is set so that the upper most portion of the outer peripheral surface of the counter shaft 33 is located at the same height or substantially the same height as the lowermost portion of the outer peripheral surface of the output shaft 40.

In the present embodiment, as schematically shown in FIG. 3, the entire case 90 accommodating the rotating electrical machine 10, the differential gear mechanism 20, and the counter gear mechanism 30 is placed below a floor 101 of the vehicle 100. That is, the drive device 1 is mounted on the vehicle 100 so that the entire case 90 overlaps the floor 101 as viewed from above and so that the case 90 is located below the floor 101.

2. Configuration of Supplying Lubricant

A configuration of supplying the lubricant as a main part of the drive device 1 according to the present embodiment will be described below with reference to FIGS. 1 and 2. As shown in FIG. 1, a first lubricant storing portion 61 that stores the lubricant is formed in the case 90. Specifically, in the present embodiment, the first lubricant storing portion 61 is a tank-like portion that is formed in a lower part of the first accommodating chamber T1 and that opens upward. The first gear 31 is placed so that a part of the first gear 31 is located in the first lubricant storing portion 61. This allows the first gear 31 to throw up the lubricant stored in the first lubricant storing portion 61 during running of the vehicle 100.

Note that in order to properly throw up the lubricant by the first gear 31, it is preferable to set the amount of lubricant to be accommodated in the case 90 so that the lowermost portion of the first gear 31 is located below the liquid height (the liquid level) of the lubricant in the first lubricant storing portion 61 in the entire rotational speed range in which the rotating electrical machine 10 is used, or in a large part of this rotational speed range.

The lubricant in the first lubricant storing portion 61 thrown up by the first gear 31 is supplied to the rotating electrical machine 10 via the lubricant supply portion 63. Note that in FIG. 1, the flow of the lubricant is conceptually represented by solid and broken arrows. The broken arrows represent the flow obtained by throwing up the lubricant, and the solid arrows represent the flow obtained by the lubricant supply portion 63. In FIG. 2, the flow of the lubricant obtained by throwing up the lubricant is conceptually represented by broken arrows. In the present embodiment, the lubricant supply portion 63 includes a lubricant receiving portion 64, lubricant flow passages 65, 66, and a second lubricant storing portion 62, and is configured to supply to the inside of the rotor shaft 12 the lubricant that is supplied by rotation of the differential gear mechanism 20 or the counter gear mechanism 30 as the power transmission mechanism (in this example, rotation of the first gear 31).

The lubricant receiving portion 64 has a function to receive the lubricant thrown up by the first gear 31. As shown in FIG. 2, the lubricant thrown up by the first gear 31 is supplied to the lubricant receiving portion 64 by flowing on the inner surface of the case 90, etc. In the present embodiment, the lubricant receiving portion 64 is configured as an oil catch tank that receives and stores the lubricant.

As shown in FIG. 2, the lubricant receiving portion 64 is placed above the second axis A2 (above a horizontal plane passing through the second axis A2) as the rotation central axis of the counter shaft 33. Note that in this example, in order to allow the lubricant to be supplied to the rotating electrical machine 10 by a simple configuration using gravity and surface tension, the lubricant receiving portion 64 is placed in an upper part of the first accommodating chamber T1 (see FIG. 2), and is placed at the same position in the axial direction L as the first gear 31 (see FIG. 1).

Specifically, the lubricant receiving portion 64 has a bottom portion 64b that covers a lower part of a lubricant storing space as a space where the lubricant is stored, a side wall portion 64c that laterally surrounds the lubricant storing space, and an opening 64a that opens to the first accommodating chamber T1. Above the lubricant storing space is covered a peripheral wall of the ease 90. Thus, the lubricant thrown up by the first gear 31 and flowing along and dropping from the inner surface of the case 90 is supplied to the inside (the lubricant storing space) of the lubricant receiving portion 64 via the opening 64a.

The lubricant flow passages 65, 66 are flow passages that allow the lubricant received by the lubricant receiving portion 64 to flow to the rotating electrical machine 10 (more precisely, the second lubricant storing portion 62). In the present embodiment, the lubricant flow passages 65, 66 are formed by holes formed in the wall portion (inside the wall) of the case 90. In the present embodiment, the lubricant flow passages 65, 66 are formed by the first lubricant flow passage 66 extending in the axial direction L, and the second lubricant flow passage 65 extending in the radial direction of the rotating electrical machine 10.

Specifically, the first lubricant flow passage 66 is formed so that one end of the first lubricant flow passage 66 opens into the lubricant receiving portion 64 via a hole formed in the side wall portion 64c of the lubricant receiving portion 64, and that the other end of the first lubricant flow passage 66 communicates with the second lubricant flow passage 65. The first lubricant flow passage 66 is located above a circumferential continuous space S (described below). Note that the first lubricant flow passage 66 may be formed to extend in a direction parallel to the horizontal direction as in the example shown in FIG. 1, or may be formed to extend obliquely downward with respect to the horizontal direction from the lubricant receiving portion 64 toward the second lubricant flow passage 65 (in the axial first direction L1).

The second lubricant flow passage 65 has an opening 65a at its end (a radially inner end portion) located on the opposite side from the portion (a radially outer end) communicating with the first lubricant flow passage 66, and the opening 65a opens to the circumferential continuous space S. The circumferential continuous space S is a space that is formed between the first bearing 71 and the second bearing 72 in the axial direction L and that is continuous in the circumferential direction of the rotor shaft 12.

The communicating portion between the first lubricant flow passage 66 and the second lubricant flow passage 65 is located above the opening 65a.

The second lubricant storing portion 62 is formed in a lower part of the circumferential continuous space S. The opening 65a of the second lubricant flow passage 65 is placed above the second lubricant storing portion 62 in the circumferential continuous space S (in this example, in the uppermost part of the circumferential continuous space S). This allows the lubricant to be properly supplied from the second lubricant flow passage 65 to the second lubricant storing portion 62 by a simple configuration of dropping the lubricant from the opening 65a by gravity to cause the lubricant to flow downward on the outer peripheral surface of the output shaft 40.

Thus, the lubricant received by the lubricant receiving portion 64 flows downstream through the lubricant flow passages 65, 66 due to gravity, is supplied to the second lubricant storing portion 62, and is stored in the second lubricant storing portion 62. As described in the following section “3. Configuration of Second Lubricant Storing Portion,” the lubricant stored in the second lubricant storing portion 62 is supplied to the shaft inner flow passage 67. The lubricant supplied to the shaft inner flow passage 67 is injected radially outside of the rotor shaft 12 via the through flow passage 68 due to a centrifugal force associated with rotation of the rotor shaft 12, and the lubricant thus blown onto the coil end portion 15 of the stator 14 cools the coil end portion 15.

3. Configuration of Second Lubricant Storing Portion The configuration of the second lubricant storing portion 62 included in the drive device 1 according to the present embodiment will be described below with reference to

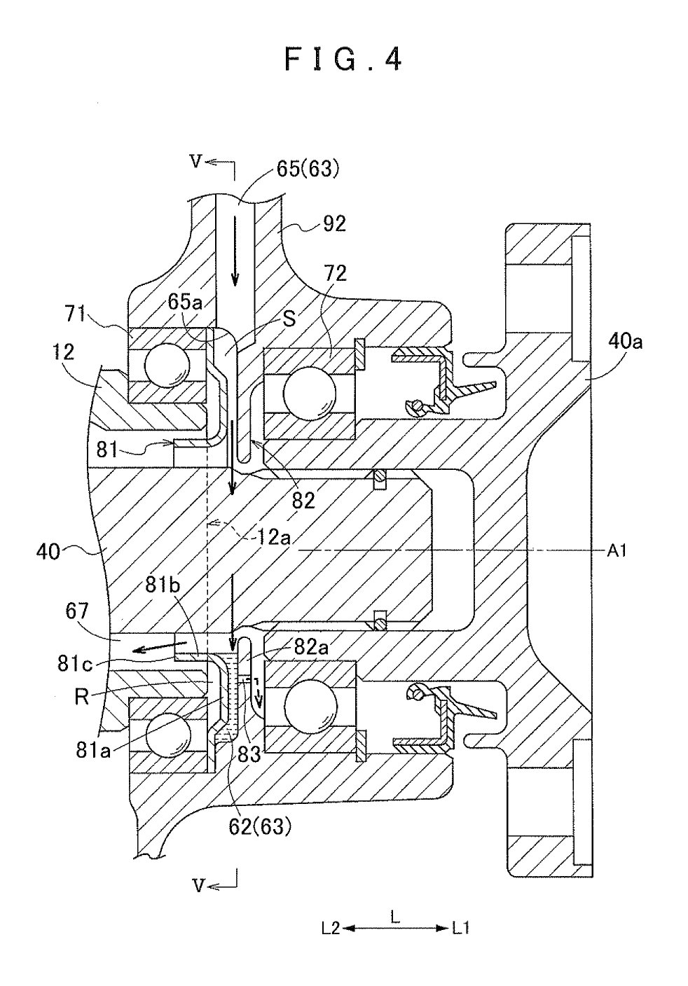

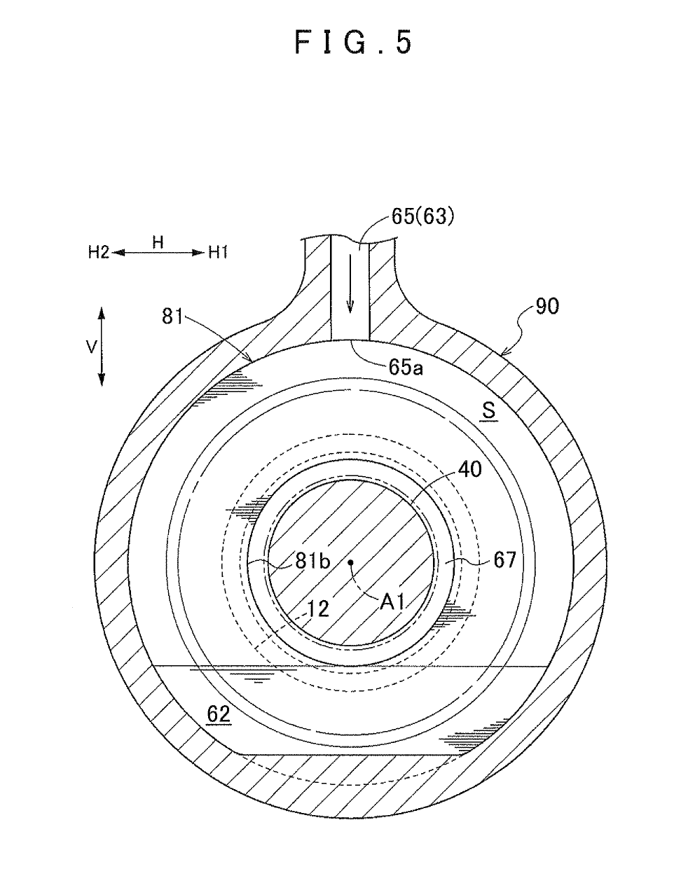

FIGS. 4 and 5. As described above, the second lubricant storing portion 62 is formed in the lower part of the circumferential continuous space S. The circumferential continuous space S is a space that is formed between the first bearing 71 and the second bearing 72 in the axial direction L and that is continuous in the circumferential direction of the rotor shaft 12. Thus, the second lubricant storing portion 62 is provided between the first bearing 71 and the second bearing 72 in the axial direction L. In the present embodiment, the second lubricant storing portion 62 corresponds to the “lubricant storing portion” in the present invention.

The second lubricant storing portion 62 is formed below the rotation central axis (the first axis A1) of the output shaft 40 in the circumferential continuous space S. Note that in the present embodiment, the circumferential continuous space S is a space that is continuous along the entire region in the circumferential direction (the entire circumference) of the rotor shaft 12. The second lubricant storing portion 62 is provided in a portion including the lowermost part of the circumferential continuous space S. As described above, the opening 65a of the second lubricant flow passage 65 is formed in the uppermost part of the circumferential continuous space S.

As shown in FIG. 4, in the present embodiment, the first bearing 71 and the second bearing 72 are arranged to have an overlapping portion as viewed in the axial direction L. In this example, the first bearing 71 is formed to have a larger diameter than the second bearing 72, and the first bearing 71 and the second bearing 72 are placed to partially overlap each other as viewed in the axial direction L. The circumferential continuous space S and the second lubricant storing portion 62 formed in the circumferential continuous space S are formed to have a region that overlaps both the first bearing 71 and the second bearing 72 as viewed in the axial direction L.

In this example, both the first bearing 71 and the second bearing 72 are rolling bearings including an inner race, an outer race, and a rolling element (a spherical element in the illustrated example). The outer peripheral surface of the rotor shaft 12 has a stepped cylindrical portion having a larger diameter on the axial second direction L2 side and having a smaller diameter on the axial first direction L1 side, and the first bearing 71 is fittingly placed on (fitted around) the smaller diameter part of the stepped cylindrical portion, and supports the rotor shaft 12 from radially outside and from the axial first direction L1 side. The outer peripheral surface of a hub member 40a included in the output shaft 40 has a stepped cylindrical portion having a larger diameter on the axial first direction L1 side and having a smaller diameter on the axial second direction L2 side, and the second bearing 72 is fittingly placed on (fitted around) the smaller diameter part of the stepped cylindrical portion, and supports the output shaft 40 from radially outside and from the axial second direction L2 side. Note that the hub member 40a spline engages with a main body portion (a columnar portion) of the output shaft 40, and is fixed by a retaining member so that movement of the hub member 40a in the axial direction L relative to the main body portion is restricted.

As shown in FIG. 5, the second lubricant storing portion 62 is formed to have a portion that communicates in the axial direction L with an opening 12a (an opening plane formed by the opening 12a) located on the axial first direction L1 side of the rotor shaft 12, at a position above the lowermost part of the opening 12a. In the present embodiment, the rotor shaft 12 is formed in a cylindrical shape, and the opening 12a on the axial first direction L1 side of the rotor shaft 12 is defined by the inner peripheral surface of the end on the axial first direction L1 side of the rotor shaft 12.

Thus, in the present embodiment, the second lubricant storing portion 62 is formed to have a portion that communicates with the shaft inner flow passage 67 of the rotor shaft 12 in the axial direction L at a position above the lowermost part of the inner peripheral surface of the end on the axial first direction L1 side of the rotor shaft 12.

In the present embodiment, only an upper part of the second lubricant storing portion 62 communicates with the opening 12a (the shaft inner flow passage 67) of the rotor shaft 12 in the axial direction L. Thus, if the liquid height in the second lubricant storing portion 62 becomes higher than the lowermost part of the portion communicating with the opening 12a, the amount of lubricant corresponding to the liquid height is supplied to the inside (the shaft inner flow passage 67) of the rotor shaft 12 via the opening 12a. That is, the lubricant overflowing the second lubricant storing portion 62 is supplied to the inside of the rotor shaft 12. This allows impurities (foreign matter etc.) contained in the lubricant to be deposited in the lower part of the second lubricant storing portion 62, whereby at least a part of the impurities can be removed from the lubricant.

If an excess amount of lubricant is supplied to the first bearing 71 and the second bearing 72, a sufficient amount of lubricant may not be able to be supplied to the rotating electrical machine 10 or excessive drag loss may be caused in the first bearing 71 and the second bearing 72. In order to avoid such problems, as shown in FIG. 4, a first annular member 81 placed on the axial first direction L1 side of the first bearing 71 to define the axial second direction L2 side of the second lubricant storing portion 62, and a second annular member 82 placed on the axial second direction L2 side of the second bearing 72 to define the axial first direction L1 side of the second lubricant storing portion 62 are provided in the present embodiment. That is, in the present embodiment, the circumferential continuous space S is formed in a gap (a gap having a predetermined width in the axial direction L) between the first annular member 81 and the second annular member 82. Note that in this example, both the first annular member 81 and the second annular member 82 are plate-like annular members (annular disc-like members). In this example, the first annular member 81 is a separate part from the case 90, and the second annular member 82 is formed integrally with the case 90.

Specifically, as shown in FIG. 4, the first annular member 81 includes a first radially extending portion 81 a formed to extend in the radial direction of the rotor shaft 12 and having a radially inner end portion located radially inward of the opening 12a. Note that a radially outer part of the first radially extending portion 81 a is fixed to the case 90 in a fluid-tight state. The second annular member 82 includes a second radially extending portion 82a formed to extend in the radial direction of the rotor shaft 12 and having a radially inner end portion located radially inward of the radially inner end portion of the first radially extending portion 81a. This allows a large part of the lubricant overflowing the second lubricant storing portion 62 to be actively guided to the axial second direction L2 side where the shaft inner flow passage 67 is formed.

In order to allow the lubricant guided to the side of the axial second direction L2 to efficiently flow into the shaft inner flow passage 67, the present embodiment uses a configuration in which the first annular member 81 includes an axially extending portion 81b in addition to the first radially extending portion 81a. As shown in FIG. 4, the axially extending portion 81b is formed to extend from the radially inner end portion of the first radially extending portion 81a to the axial second direction L2 side, and to have a tip end 81c located inside the rotor shaft 12. This allows the lubricant overflowing the second lubricant storing portion 62 to the side of the axial second direction L2 to be reliably supplied from the tip end 81c into the shaft inner flow passage 67 along the axially extending portion 81b.

Note that in the present embodiment, as shown in FIG. 4, a gap in the radial direction is formed between the axially extending portion 81b and the inner peripheral surface of the rotor shaft 12. The first radially extending portion 81a is formed in a stepped annular shape having its radially inner part being offset to the axial first direction L1 side with respect to its radially outer part (the part fixed to the case 90), so that a gap R in the axial direction L is formed between the first radially extending portion 81a and the end on the axial first direction L1 side of the rotor shaft 12. This allows a part of the lubricant supplied to the shaft inner flow passage 67 to be supplied to the first bearing 71 to lubricate this bearing.

Moreover, in order to allow the second bearing 72 to be lubricated as well, the present embodiment uses a configuration in which the second annular member 82 includes one or more (in this example, one) through holes 83. This through hole 83 is formed to extend through the second radially extending portion 82a in the axial direction L below the bottom of the radially inner end portion of the first radially extending portion 81a. This allows the amount of lubricant according to a diameter of the through hole 83 to actively flow out of the second lubricant storing portion 62 to the side of the axial first direction L1 and to be supplied to the second bearing 72. Note that the lubricant that has lubricated the second bearing 72 is returned to the first lubricant storing portion 61 via a flow passage (not shown).

4. Other Embodiments

Lastly, other embodiments according to the present invention will be described. Note that the characteristics described in each of the following embodiments are not applicable only in that embodiment, but are applicable to the other embodiments as long as no inconsistency arises.

(1) In the embodiment described above, as an example, the first annular member 81 includes the axially extending portion 81b, and the second annular member 82 includes the through hole 83. However, embodiments of the present invention are not limited to this example, and the second annular member 82 may not include the through hole 83. The first annular member 81 may not include the axially extending portion 81b, depending on the separation distance in the axial direction L between the first radially extending portion 81 a and the opening 12a of the rotor shaft 12. The above embodiment is described with respect to an example configuration in which the first annular member 81 is a separate part from the case 90, and the second annular member 82 is formed integrally with the case 90. However, the first annular member 81 may be formed integrally with the case 90, and the second annular member 82 may be a separate part from the case 90. Alternatively, both the first annular member 81 and the second annular member 82 are separate parts from the case 90, or both the first annular member 81 and the second annular member 82 may be formed integrally with the case 90.

(2) In the embodiment described above, as an example, both the first annular member 81 and the second annular member 82 are provided. However, embodiments of the present invention are not limited to this example. That is, only one of the first annular member 81 and the second annular member 82 may be provided, or neither the first annular member 81 nor the second annular member 82 may be provided.

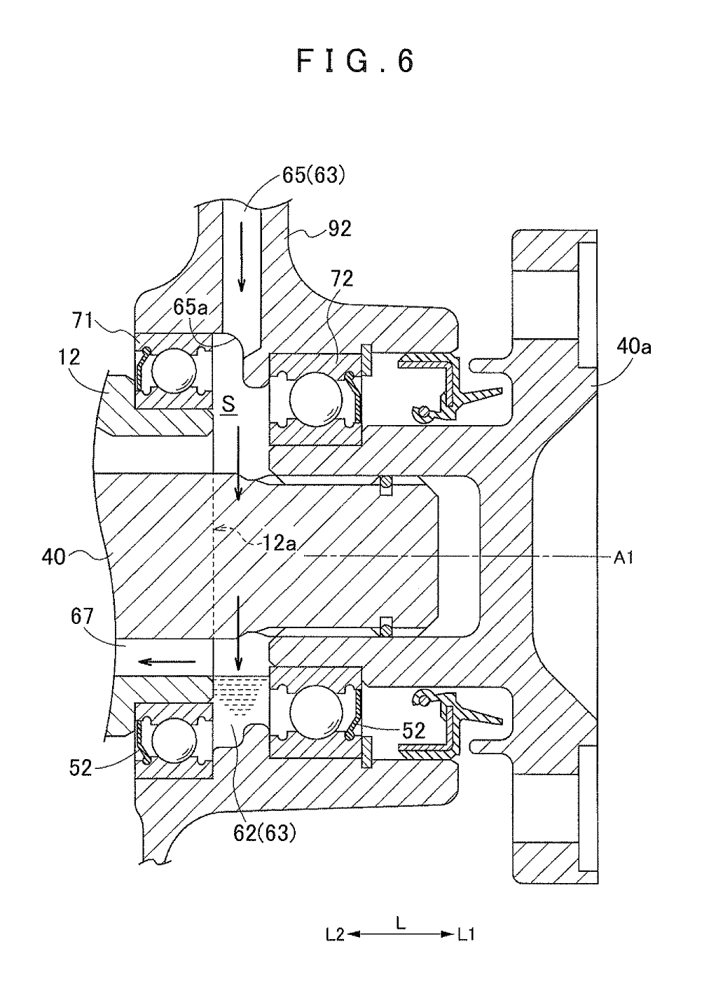

An example of the latter configuration is shown in FIG. 6. In the example shown in FIG. 6, bearings each having a restricting member 52 that restricts the flow of the lubricant between inner and outer races are used as the first bearing 71 and the second bearing 72. This allows the lubricant to be properly stored in the second lubricant storing portion 62.

Note that in the example shown in FIG. 6, the first bearing 71 includes the restricting member 52 on the axial second direction L2 side with respect to the rolling element, and the second bearing 71 includes the restricting member 52 on the axial first direction L1 side with respect to the rolling element. This allows both the first bearing 71 and the second bearing 72 to be lubricated.

(3) In the embodiment described above, as an example, the second lubricant storing portion 62 is formed to have a region that overlaps both the first bearing 71 and the second bearing 72 as viewed in the axial direction L. However, embodiments of the present invention are not limited to this example, and the second lubricant storing portion 62 may be formed to have a region that overlaps only one of the first bearing 71 and the second bearing 72 as viewed in the axial direction L, or the second lubricant storing portion 62 may be formed so as not to have a region that overlaps the first bearing 71 and the second bearing 72 as viewed in the axial direction L.

The above embodiment is described with respect to an example configuration in which the first bearing 71 and the second bearing 72 are arranged to have an overlapping portion as viewed in the axial direction L, but the first bearing 71 and the second bearing 72 may be arranged so as not to have an overlapping portion as viewed in the axial direction L.

(4) In the embodiment described above, as an example, the second lubricant storing portion 62 is formed on the axial first direction L1 side with respect to the rotating electrical machine 10 (more specifically, the rotor core 11 of the rotating electrical machine 10). However, embodiments of the present invention are not limited to this example, and the second lubricant storing portion 62 may be formed on the axial second direction L2 side (the rotating electrical machine output gear 13 side) with respect to the rotating electrical machine 10 (more specifically, the rotor core 11 of the rotating electrical machine 10). In this case, the third bearing 73 may be the “first bearing” in the present invention, the fourth bearing 74 may be the “second bearing” in the present invention, and the second lubricant storing portion 62 may be formed between the third bearing 73 as the first bearing and the fourth bearing 74 as the second bearing in the axial direction L. Note that in the example shown in FIG. 1, two bearings that support the rotating electrical machine output gear 13 are placed on the axial second direction L2 side with respect to the third bearing 73. Accordingly, the second lubricant storing portion 62 can be fanned by using a gap U in the axial direction L between one of the two bearings, which is located on the axial second direction L2 side, and the fourth bearing 74.

(5) In the embodiment described above, as an example, the lubricant thrown up by the first gear 31 is supplied to the second lubricant storing portion 62. However, embodiments of the present invention are not limited to this example, and the lubricant may be thrown up by a gear (e.g., the differential input gear 21) other than the first gear 31, which rotates with rotation of the output shaft 40. In such a configuration, unlike the above embodiment, the rotation central axis of the counter shaft 33 may be placed at the same height as the rotation central axis of the rotating electrical machine 10, or the rotation central axis of the counter shaft 33 may be placed above the rotation central axis of the rotating electrical machine 10. In the embodiment described above, as an example, the lubricant thrown up by the throwing member is supplied to the second lubricant storing portion 62. However, a pump that is driven by rotation of the power transmission mechanism may be provided so that the lubricant discharged from the pump is supplied to the second lubricant storing portion 62.

(6) In the embodiment described above, as an example, the circumferential continuous space S is a space that is continuous along the entire region in the circumferential direction (the entire circumference) of the rotor shaft 12. However, embodiments of the present invention are not limited to this example, and the circumferential continuous space S may be formed to be continuous only in a part (e.g., half the circumference) of the circumference of the rotor shaft 12 instead of the entire circumference of the rotor shaft 12.

(7) In the embodiment described above, as an example, the lubricant flow passages 65, 66 are holes formed in the wall portion of the case 90. However, embodiments of the present invention are not limited to this example, and at least a part of lubricant flow passage 65, 66 may be formed by a groove etc. formed in the wall surface of the case 90, or may be formed by a pipe-shaped member, a gutter-shaped member, etc. placed inside or outside the case 90.

(8) In the embodiment described above, as an example, both the first bearing 71 and the second bearing 72 are rolling bearings having a spherical element as a rolling element. However, embodiments of the present invention are not limited to this example, and bearings in other forms, such as a roll bearing having as a rolling element an element (e.g., a columnar element, a conical element, etc.) other than a spherical element or a slide bearing, may be used as one or both of the first bearing 71 and the second bearing 72.

(9) Regarding other configurations as well, the embodiments disclosed in the specification are by way of example only in all respects, and embodiments of the present invention are not limited to them. That is, it is to be understood that configurations obtained by partially modifying as appropriate the configurations that are not described in the claims of the present application also fall in the technical scope of the present invention, as long as these configurations include the configurations described in the claims and the configurations equivalent thereto.

The present invention can be preferably used for vehicle drive devices including a rotating electrical machine, a through shaft placed to extend through a cylindrical rotor shaft of the rotating electrical machine in the axial direction, a power transmission mechanism that transmits power between the rotor shaft and the through shaft, a lubricant supply portion that supplies, to the inside of the rotor shaft, lubricant that is supplied by rotation of the power transmission mechanism, and a case that accommodates at least the rotating electrical machine and the power transmission mechanism.

What is claimed is:

1. A vehicle drive device, comprising:
a rotating electrical machine;
a through shaft placed to extend through a cylindrical rotor shaft of the rotating electrical machine in an axial direction;
a power transmission mechanism that transmits power between the rotor shaft and the through shaft;
a lubricant supply portion that supplies, to inside of the rotor shaft, lubricant that is supplied by rotation of the power transmission mechanism;
a case that accommodates at least the rotating electrical machine and the power transmission mechanism;
a first bearing placed on an axial first direction side as one side in the axial direction with respect to the rotating electrical machine, and placed radially outward of the rotor shaft to support the rotor shaft; and
a second bearing placed on the axial first direction side with respect to the first bearing, and placed radially outward of the through shaft to support the through shaft, wherein
the lubricant supply portion includes a lubricant storing portion which is located between the first bearing and the second bearing in the axial direction at a position below a rotation central axis of the through shaft, and stores the lubricant, and
the lubricant storing portion is formed to have a portion that communicates in the axial direction with an opening located on the axial first direction side of the rotor shaft, at a position above a lowermost part of the opening.

2. The vehicle drive device according to claim 1, wherein:
the first bearing and the second bearing are arranged to have an overlapping portion as viewed in the axial direction; and
the lubricant storing portion is formed to have a region that overlaps both the first bearing and the second bearing as viewed in the axial direction.

3. The vehicle drive device according to claim 2, further comprising:
a first annular member that is placed on the axial first direction side of the first bearing to define an axial second direction side of the lubricant storing portion, which is an opposite side from the axial first direction side; and a second annular member that is placed on the axial second direction side of the second bearing to define the axial first direction side of the lubricant storing portion, wherein
the first annular member includes a first radially extending portion formed to extend in a radial direction of the rotor shaft and having a radially inner end portion located radially inward of the opening, and an axially extending portion formed to extend from the radially inner end portion of the first radially extending portion to the axial second direction side and having a tip end located inside the rotor shaft,
the second annular member includes a second radially extending portion formed to extend in the radial direction and having a radially inner end portion located radially inward of the radially inner end portion of the first radially extending portion, and
a through hole extending through the second radially extending portion in the axial direction is formed below a bottom of the radially inner end portion of the first radially extending portion.

4. The vehicle drive device according to claim 3, wherein:
the power transmission mechanism includes a throwing member that throws up the lubricant in the case;
the lubricant supply portion includes a lubricant receiving portion that receives the lubricant thrown up by the throwing member, and a lubricant flow passage that allows the lubricant received by the lubricant receiving portion to flow to the lubricant storing portion;
the lubricant storing portion is formed in a lower part of a circumferential continuous space that is formed between the first bearing and the second bearing in the axial direction and that is continuous in a circumferential direction of the rotor shaft; and
the lubricant flow passage opens at a position above the lubricant storing portion in the circumferential continuous space.

5. The vehicle drive device according to claim I, further comprising:
a first annular member that is placed on the axial first direction side of the first bearing to define an axial second direction side of the lubricant storing portion, which is an opposite side from the axial first direction side; and a second annular member that is placed on the axial second direction side of the second bearing to define the axial first direction side of the lubricant storing portion, wherein
the first annular member includes a first radially extending portion formed to extend in a radial direction of the rotor shaft and having a radially inner end portion located radially inward of the opening, and an axially extending portion formed to extend from the radially inner end portion of the first radially extending portion to the axial second direction side and having a tip end located inside the rotor shaft,
the second annular member includes a second radially extending portion formed to extend in the radial direction and having a radially inner end portion located radially inward of the radially inner end portion of the first radially extending portion, and
a through hole extending through the second radially extending portion in the axial direction is formed below a bottom of the radially inner end portion of the first radially extending portion.

6. The vehicle drive device according to claim 1, wherein:
the power transmission mechanism includes a throwing member that throws up the lubricant in the case;
the lubricant supply portion includes a lubricant receiving portion that receives the lubricant thrown up by the throwing member, and a lubricant flow passage that allows the lubricant received by the lubricant receiving portion to flow to the lubricant storing portion;
the lubricant storing portion is formed in a lower part of a circumferential continuous space that is formed between the first bearing and the second bearing in the axial direction and that is continuous in a circumferential direction of the rotor shaft; and
the lubricant flow passage opens at a position above the lubricant storing portion in the circumferential continuous space.

7. The vehicle drive device according to claim 2, wherein:
the power transmission mechanism includes a throwing member that throws up the lubricant in the case;
the lubricant supply portion includes a lubricant receiving portion that receives the lubricant thrown up by the throwing member, and a lubricant flow passage that allows the lubricant received by the lubricant receiving portion to flow to the lubricant storing portion;
the lubricant storing portion is formed in a lower part of a circumferential continuous space that is formed between the first bearing and the second bearing in the axial direction and that is continuous in a circumferential direction of the rotor shaft; and
the lubricant flow passage opens at a position above the lubricant storing portion in the circumferential continuous space.

8. The vehicle drive device according to claim 5, wherein:
the power transmission mechanism includes a throwing member that throws up the lubricant in the case;
the lubricant supply portion includes a lubricant receiving portion that receives the lubricant thrown up by the throwing member, and a lubricant flow passage that allows the lubricant received by the lubricant receiving portion to flow to the lubricant storing portion;
the lubricant storing portion is formed in a lower part of a circumferential continuous space that is formed between the first bearing and the second bearing in the axial direction and that is continuous in a circumferential direction of the rotor shaft; and
the lubricant flow passage opens at a position above the lubricant storing portion in the circumferential continuous space.
